(19) United States
(12) Patent Application Publication
(10) Pub. No.: US 2022/0207599 A1
(43) Pub. Date: Jun. 30, 2022

(54) Method for Operating a Web Platform for Selling Products

(71) Applicants: Meir Dahan, Adi (IL); Eliahu Antopolsky, Zichron Yaakov (IL)

(72) Inventors: Meir Dahan, Adi (IL); Eliahu Antopolsky, Zichron Yaakov (IL)

(21) Appl. No.: 17/138,953

(22) Filed: Dec. 31, 2020

(51) Int. Cl. G06Q 30/08; G06Q 30/06; G06F 17/10; G06F 9/54; H04L 29/08

(52) U.S. Cl. CPC G06Q 30/08; G06Q 30/0641; H04L 67/02; G06F 9/542; G06F 17/10

(57) ABSTRACT

A method for operating a web platform for selling a product that is performed by processing devices running on computing devices and a server that enables a user to advertise the product for sale and indicate a deadline for submitting purchase offers, enables the user to specify a minimum bid, receives from the user an undertaking to sell the product to a person who will offer at least the minimum bid, saves the minimum bid price in a memory means in the server, enables bidders to submit purchase offers, saves these offers, and on the deadline or after selects the submitted purchase offer with the highest price, and calculates a final price at which that bidder will purchase the product according to a mathematical formula in such a way that the calculated final price is between the minimum bid price and the highest price.

### TECHNICAL FIELD

The present invention refers to a method for operating a web platform for selling products.

### BACKGROUND ART

There is a wide variety of web platforms such as websites and smartphone applications for selling products, new or second hand, that operate on the basis of an auction method. The present invention discloses a method for operating a web platform for selling products that is more likely to be attracted to sellers and buyers.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 illustrates a computing device (100) of a user, another computing device (100) of a bidder and a server (200), that each of them includes a processing device (10).

### THE INVENTION

The main object of the present invention is to provide a method for operating a web platform for selling a product that is performed by processing devices (10) running on a computing device (100) and a server (200). The term “computing device” (100) hereinafter and in the claims refers to any kind of device which is designed to have internet connection, such as smartphones, computers, tablets and the like.

A web platform such as a computer program or a mobile application may be used as a framework for the overall operation and use of the method and for the sake of fluency we will use the terms “web platform” and “method” hereinafter in this connection and as having in general the same meaning. People will have access to the web platform that can be for example a website, a smartphone application, and text messages systems that works over internet or cellular networks and the like, and to act in the web platform as sellers or bidders.

The method is designed specifically for operating a web platform for selling a product that is performed by the processing devices that are running on the computing devices and on the server. The method basically includes the following main substantial steps:

(a) The web platform enables a user of a computing device to advertise a product for sale on the web platform and to indicate a deadline for submitting purchase offers. The deadline can be a date or a condition, such as that after receiving a certain amounts of purchase offers the web platform choose the winner.

(b) The web platform enables the user to specify a minimum bid price for the product. It is possible that this minimum bid price may not be disclosed or may be disclosed to the public (to bidders) according to a decision of the user or the web platform. Minimum bid price that also known as “reserve price” is the price at which an item can be sold. If the final bid does not reach the minimum bid, the item remains unsold. Indeed, the starting bid can be less than the minimum bid, but the item cannot be sold until it reaches that bid.

(c) The web platform displays on the computing device of the user a requirement from the user to provide an undertaking that he or she legally must sell the product to a person who will offer at least said minimum bid price, and receiving from the user said undertaking. This step is designed to ensure that in case of receiving a purchase offer at a price equal to or higher the minimum bid price, then the sale transaction is legally created and should be executed by the parties. To ensure the realization of the transaction, credit card details can be requested from all parties as security.

(d) The web platform saves the minimum bid price in a memory means in the server.

(e) The web platform enables bidders to submit through computing devices purchase offers for the product, in a way that each purchase offer should include a price at which each bidder agrees to purchase the product.

(f) The web platform saves the submitted purchase offers of the bidders in the memory means in the server.

(g) The web platform selects automatically, on the deadline or after, the submitted purchase offer with the highest price.

(h) The method automatically calculates in the memory means that is in the server a final price at which the bidder that submitted the selected purchase offer with the highest price will purchase the product from the seller. The calculation of the final price is done according to a mathematical formula in such a way that the calculated final price is between the minimum bid price and the highest price. For example, it is possible that the final price will be the middle amount between the minimum bid price and the highest price or a middle amount between the minimum bid price and the highest price after deducting a commission or expenses for the operator of the website.

(i) The method automatically sends a notice to the user as well as to the bidder that submitted the selected purchase offer regarding the winning bid and the final price for completing the transaction.

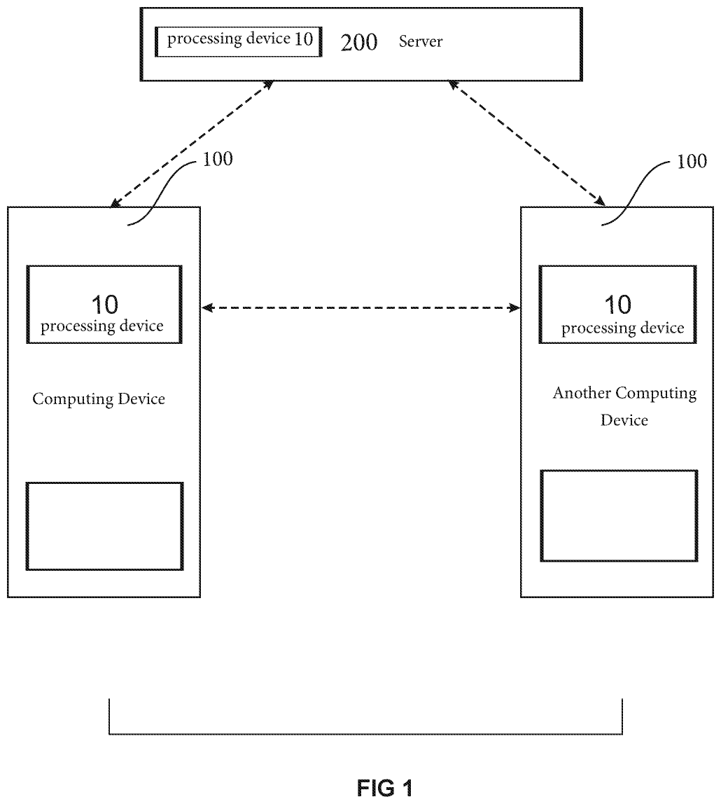

FIG. 1 illustrates a computing device (100) of a user, another computing device (100) of a bidder and a server (200), that each of them includes a processing device (10).

The present invention discloses a second version of the method for operating the web platform for selling the product that comprises the following steps: (a) The web platform enables the user to advertise the product for sale on the web platform. (b) The web platform enables the user to specify the minimum bid price that can be undisclosed. (c) The web platform displays the requirement to provide the undertaking to sell the product to a person who will offer at least the minimum bid price and to receive this undertaking. (d) The web platform saves the minimum bid price in a memory means. The web platform enables a bidder to submit a purchase offer that includes a price at which the bidder agrees to purchase the product. (f) The web platform saves the submitted purchase offer of the bidder. (h) The web platform calculates automatically the final price at which the bidder will purchase the product according to the mathematical formula, as explained above. This version cab may be used by businesses that sell many units of the same product.

What is claimed is:

1. A method for operating a web platform for selling a product that is performed by processing devices running on a computing device and a server, comprising:
(a) enabling a user of the computing device to advertise the product for sale on the web platform and to indicate a deadline for submitting purchase offers;
(b) enabling the user to specify a minimum bid price for the product, wherein said minimum bid price can be disclosed or undisclosed to the public;
(c) receiving from the user an undertaking that he or she legally agree to sell the product to a person who will offer at least the minimum bid price;
(d) saving the minimum bid price in a memory means in the server;
(e) enabling bidders to submit through computing devices purchase offers for the product that include prices at which each bidder agrees to purchase the product;
(f) saving the submitted purchase offers of the bidders in the memory means in the server;
(g) on the deadline or after, automatically selecting a submitted purchase offer with a highest price for purchasing the product;
(h) calculating automatically in the memory means in the server a final price at which a bidder that submitted the selected purchase offer with the highest price will purchase the product from the seller according to a mathematical formula in such a way that said calculated final price is between said minimum bid price and said highest price;
(i) sending a notice to the user as well as to the bidder that submitted the selected purchase offer regarding the final price for completing the transaction.

2. The method according to claim 1 wherein said final price is the middle amount between said minimum bid price and said highest price or a middle amount between said minimum bid price and said highest price after deducting a commission or expenses for an operator of the website.

3. A method for operating a web platform for selling a product that is performed by processing devices running on a computing device and a server, comprising:
(a) enabling a user of the computing device to advertise the product for sale on the web platform;
(b) enabling the user to specify a minimum bid price for the product, wherein said minimum bid price can be undisclosed or undisclosed;
(c) saving the minimum bid price in a memory means in the server;
(d) enabling a bidder to submit through computing devices a purchase offer for the product that includes a price at which the bidder agrees to purchase the product;
(e) saving the submitted purchase offer of the bidder in the memory means in the server;
(f) calculating automatically in the memory means in the server a final price at which the bidder will purchase the product from the seller according to a mathematical formula in such a way that said calculated final price is between said minimum bid price and said price;
(g) sending a notice to the user as well as to the bidder regarding the final price for completing the transaction.

4. The method according to claim 3 wherein said final price is the middle amount between said minimum bid price and said price or a middle amount between said minimum bid price and said price after deducting a commission or expenses for an operator of the website.
